(19) United States
(12) Patent Application Publication
(10) Pub. No.: US 2008/0034720 A1
(43) Pub. Date: Feb. 14, 2008

(54) Engine load control for hydrostaticaly driven equipment

(76) Inventors: James C. Helfrich, Sun River, MT (US); George J. Kuchar, Carlinville, IL (US)

Correspondence Address: James C. Helfrich, 200 Choteau St, Sun River, MT, 59483, US

(21) Appl. No.: 11/503,453

(22) Filed: Aug. 11, 2006

(51) Int. Cl. A01D 41/127

(52) U.S. Cl. 56/10.2 R

(57) ABSTRACT

A harvester load control that increases the efficiency of the harvester and its operator by providing a automatic control unit that monitors minute engine RPM's caused by varying crop and transport load effects, automatically adjusting the harvester's ground speed to provide a consistent operational RPM including thrashing, separating and other conditioning services.

### RELATED APPLICATIONS

The present application is related to U.S. Pat. No. 4,458,471, issued Jul. 10, 1984, by Herwig, included by reference herein.

The present application is related to U.S. Pat. No. 4,727,710, issued Mar. 1, 1988, by Kuhn, included by reference herein.

The present application is related to U.S. Pat. No. 6,591,591, issued Jul. 15, 2003, by Coers, included by reference herein.

The present application is related to U.S. Pat. No. 6,941,736, issued Oct. 13, 2005, by Freeman, included by reference herein.

The present application is related to U.S. Pat. No. 4,542,802, issued Sep. 24, 1985, by Garvey, included by reference herein.

### FIELD OF THE INVENTION

The present invention relates to an engine load control and, more particularly, to a load control for hydrostatically or hydraulically driven equipment maintaining a consistent and selectable engine RPM under various loads.

### BACKGROUND OF THE INVENTION

Combines and other harvesting equipment encounter extremely wide crop conditions throughout the field. These conditions include varying crop densities, ripeness, moisture content and toughness. All of these conditions affect the way the harvesting machine process the crop. In conditions where the crop suddenly increases in volume, the combine will not process all of the crop causing some of it to be lost out of the back into the field and an other portion to bypass the holding tank to be reprocessed which further compounds the problem. In other circumstances the crop my be lighter in yield which creates a situation where when the machine is adjusted to handle heavier crop can cause the crop to be blown out the rear of the machine by the fans used for cleaning.

Varying crop yields and harvesting conditions make it difficult for the harvester operator to adjust the machine. When it is adjusted in one portion of the field for that particular location's conditions it may be way off when the machine gets to another location in the field. This makes for greater crop loss, crop damage and inefficient use of the machine. As the crop lightens the machines engine RPM's accelerate often furthering the problems just discussed. if the machine is over loaded the engine RPM's drop resulting in the slowing of the machines thrashing and separating systems adversely affecting their performance. The operator cannot detect the tens of thousands of varying conditions he encounters throughout the day and even if he could he is unable to instantly predict the correct change and make that change. Because of these issues operators and harvesting equipment is often less than efficient resulting in lost crop, lost quality, lost efficiency of labor fuel and more damage to the machine. When sudden crop changes occur that can actually slug the harvester resulting in a sudden drop in RPM the harvester can actually become plugged. This plugging of the machine always results in lost productivity and sometimes results in damage to the machine or danger to the operator.

Freeman in U.S. Pat. No. 6,941,736 uses a system that monitors the output of the machine and warns the operator though an alarm system. There have been other early warning type designs similar to this that warn when overloads have occurred. Coers in U.S. Pat. No. 6,591,591 uses a system based upon header position. When the header is lowered during cutting the harvester speed is immediately decreased to prevent a sudden increase in material down stream with a reduction equal to the estimated percentage increase in material for the given height change. Garvey in U.S. Pat. No. 4,542,802 uses electonics over hydraulics to control the forward speed of the combine based upon engine droop and two stage govenor.

Kuhn in U.S. Pat. No. 4,727,710 proposes to maintain the ground speed for harvesting efficiency through an automatic means of maintaining a pre established ground speed. Herwig in U.S. Pat. No. 4,458,471 offers a means of controlling ground speed by identifying the limiting means of the harvester through a plurality of sensors including at least sensors mounted on the ground speed, boost pressure and engine speed

Other solutions do not take in consideration that the human operator is both too slow and too distracted to respond to manual warning signals. Any operator concentrating for a warning signal, which would occur nearly constantly in fields with varying conditions, would soon become fatigued and confused. They do not free up the operator for more important and controllable occurrences in or out of the harvesting machine that are a fact of operator life in a harvester.

Kuhn does not take into consideration that ground speed must be varied not maintained in order to maintain a consistent flow of crop materials into the harvester in order to reach maximum efficiency and quality.

Coers assumes that crop conditions are tied to cutting height, when in fact cutting height is only one of the several parameters that affects the crop load and difficulty of harvest. For example, a crop that is the same height will vary in toughness from early in the morning until mid day, becoming less tough to harvest, thrash and separate as the middle of the day is reached and then reverse itself as the evening falls and due land moisture levels once again increase.

Herwig proposes multiple sensors which have proven to confuse and complicate the decision making ability of the controller. Ground speed changes for instance will occur in perfectly even crops when the harvester is going up or down a hill as opposed to being run on level ground. Soft ground will provide a greater load than hard ground because of tire sink and traction loss. Even the fuel and grain tank level will create a varying load that will effect ground speed. Boost pressure is also adversely affected because of conditions that are unique to it. Garvey provides no safety measures for over speed or for protecting an operator if the target RPM is reached. The unit is not programmable making it difficult for an operator to set and operate the system. Hydraulic operation prevents the unit from as fast an operation as is required for optimum operation. The Garvey unit does not take into consideration that consistent crop flow through the harvester is paramount to effective operation because it slows the harvester on uphill grades based solely upon transport load and allows the harvester to increase ground speed on downhill slopes again based solely upon transport loads.

None of the prior art suggests the understanding that only one component on the harvester provides an accurate read when read at extremely high rates to determine its collective conditions, the engine and the engine alone.

It is therefore an object of the invention to increase the harvesting efficiency of any hydrostatically driven harvester.

It is another object of the invention to reduce fatigue on the operator.

It is another object of the invention to reduce down time caused by slugging or breakdowns.

It is another object of the invention to reduce fuel consumption.

It is another object of the invention to reduce crop damage due to over thrashing of the crop.

It is another object of the invention to reduce crop loss do to underlaoding of the harvester.

It is another object of the invention to increase area harvested by maintaining the maximum speed for the crop conditions.

It is another object of the invention to reduce operator skill level requirements.

It is another object of the invention to produce crops acceptable to the pharmaceutical industry through greatly increased crop quality.

### SUMMARY OF THE INVENTION

In accordance with the present invention, there is provided a harvester load control that will increase the efficiency of the harvester and its operator by providing a control unit that monitors minute engine RPM changes caused by varying crop and transport load effects, automatically adjusting the harvesters ground speed to provide a consistent operational RPM including thrashing, separating and other conditioning services.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a left elevation view of a combine type harvester;

FIG. 2 is a schematic perspective view of a harvester load effects;

FIG. 3 is a schematic perspective view of a load control operational flow; and

FIG. 4 is a schematic perspective view of a load control and its components.

For purposes of clarity and brevity, like elements and components will bear the same designations and numbering throughout the Figures.

### DESCRIPTION OF THE PREFERRED EMBODIMENT

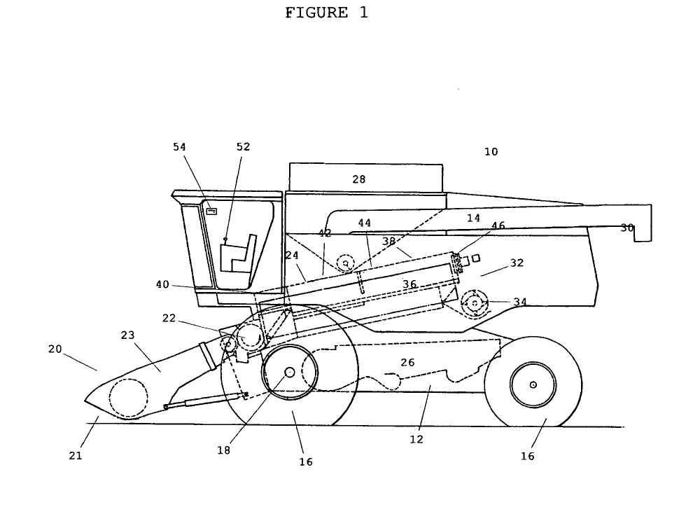

FIG. 1 is a left elevation view of a combine 10 type harvester.

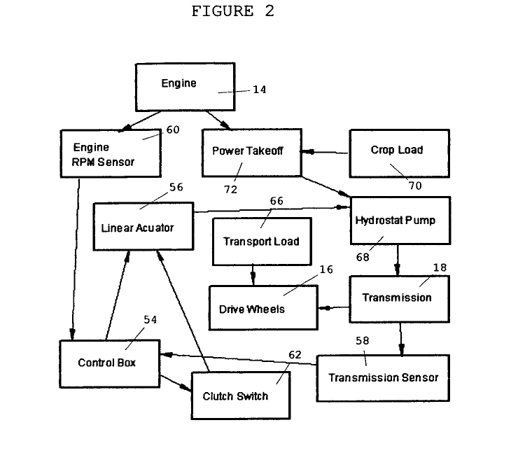

FIG. 2 is a schematic perspective view of a harvester load effects.

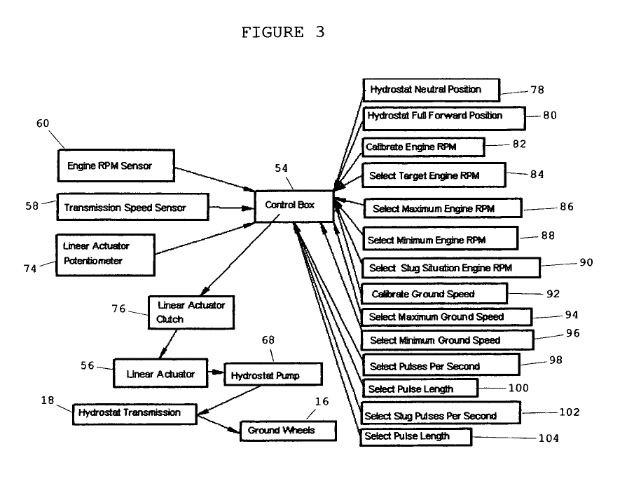

FIG. 3 is a schematic perspective view of a load control operational flow.

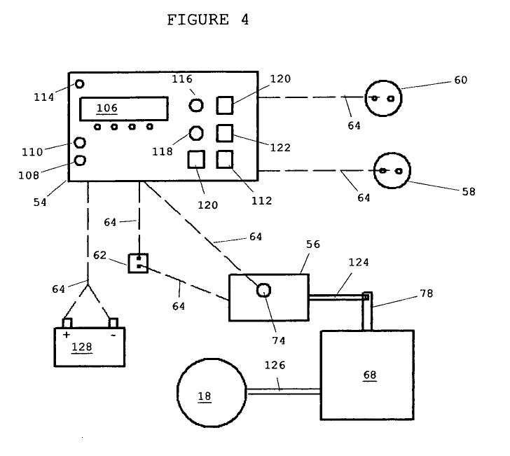

FIG. 4 is a schematic perspective view of a load control and its components.

Referring to FIG. 1, therein is shown an agricultural harvester comprising a main frame 12 supported for movement by a wheel structure including drive wheels 16 driven by a hydrostatic transmission 18. The wheel structure depicted could include or be composed of ground engaging tracks or multiples of wheels 16 other than shown.

A vertically adjustable header or harvesting platform 20 with a cutter bar 21 is used for cutting a standing crop and directing cut material further processing. FIG. 1 depicts one type of harvester known as a combine 10 which includes crop processing features such as the feeder house 23 that is pivotally connected to the frame 12 and includes a conveyor for conveying the cut material to a beater 22. The beater 22 directs the material upwardly to a rotary threshing and separating assembly 24. Other orientations and types of threshing structures and other types of headers, such as transverse frame 12 supporting individual row units, could also be utilized on combines and other types of harvesters such as choppers, windrowers, cotton harvesters, grape harvesters and other hydrostatically driven harvesters for agricultural and pharmaceutical harvesting could be substituted for the example provided.

The rotary threshing and separating assembly 24 threshes and separates the harvested crop material. Grain and chaff fall through grates on the bottom of the assembly to a cleaning system 26. The cleaning system 26 removes the chaff and directs the clean grain to a clean grain elevator (not shown). The clean grain elevator deposits the clean grain in grain tank 28. The clean grain in the tank can be unloaded into a grain cart or truck by unloading auger 30.

Threshed and separated straw is discharged from the crop processing unit through outlet 32 to discharge beater 34. The discharge beater 34 in turn propels the straw out the rear of the combine 10. It should be noted that the discharge beater 34 could also discharge crop material other than grain directly to a straw chopper. The operation of the harvester is controlled from an operator's cab or if not manned from an operations center located on the harvester and controlling the harvesters operations from a remote location or robotic control operations.

In this example the rotary threshing and separating assembly 24 comprises cylindrical rotor 36 housing 38 and a hydraulically driven rotor 36 located inside the housing 38. The front part of the rotor 36 and the rotor 36 housing 38 define the infeed section 40. Downstream from the infeed section 40 are the threshing section 42, the separating section 44 and the discharge section 46. The rotor 36 in the infeed section 40 is provided with a conical rotor 36 drum having helical infeed elements for engaging harvested crop material received from the beater 22 and inlet transition section 48. Immediately downstream from the infeed section 40 is the threshing section 42. In the threshing section 42 the rotor 36 comprises a cylindrical rotor 36 drum having a number of threshing elements for threshing the harvested crop material received from the infeed section 40.

Downstream from the threshing section 42 is the separating section 44 wherein the grain trapped in the threshed crop material is released and falls through a floor grate in the rotor 36 housing 38 to the cleaning system 26. The separating section 44 merges into a discharge section 46 where crop material other than grain is expelled from the rotary threshing and separating assembly 24. Although the harvester is shown as a combine 10 for harvesting grain, it is to be understood that the present invention may also be utilized with other types of harvesters.

Harvester speed is controlled automatically by a linear actuator 56 operably connected to the hydrostatic pump or other hydraulically driven transmission hydrostat handle 52. The controller adjusts a variable position lever at the output pump to drive the wheels 16 at the desired operating speed. The operator can control speed in a manual mode through a conventional hydrostat control handle located in the cab. The operator establishes an upper speed limit for the harvester to prevent runaway of the machine and a lower end speed limit to prevent accidental engagement of the drive wheels 16 when the machine is being serviced and the engine 14 run to operating speed. Both of these functions are provided or safety purpose and not for general operation of the machine. Speed is infinitely variable within the range of the upper and lower speed limits. A speed signal sensor, in a preferred embodiment a Hall Effect sensor, provides signal to the input of the controller. The controller monitors the speed to make safety decisions. If the ground speed 92 is below the minimum safety speed setting the controller will not permit the actuator to move the hydrostat pump 68 lever to increase ground speed 92. If the controller attempts to increase ground speed 92 to decrease engine 14 RPMs and that would cause a ground speed 92 above the maximum ground speed 94 94 safety setting the controller will not signal the actuator to increase ground speed 92. It is understood that hydrostat pump 68 is a term used because of its familiarity to harvesters but the invention is to understood to apply to any hydraulically driven type harvesting machine.

Referring to FIG. 2, a system for controlling the drive train of the harvester of FIG. 1 is illustrated in block diagram form. The output shaft of the engine 14 is connected to the drive wheels 16 of the harvester through a transmission. Most modern harvesters use hydrostatic transmissions, which offer an “infinitely variable” gear ratio between the engine 14 and the drive wheels 16. As a result, the load imposed on the engine 14 through the transmission, which will be referred to herein as the “transport load 66”, can be varied over an “infinite” number of settings within the operating range of the transmission. In effect, the setting of the hydrostatic transmission 18 controls the division of the power output of the engine 14 between the transport load 66 and the processing-harvesting mechanisms coupled to the engine 14 through a power takeoff 72 located between the engine 14 and the hydrostatic transmission 18. This power takeoff 72 normally has a fixed gear ratio. The load imposed on the engine 14 by the processing-harvesting mechanisms will be referred to herein as the “crop load 70”.

Both the transport load 66 and the processing load are continually changing. By adjusting the setting of the hydrostatic transmission 18 with either changing load conditions, the total actual load on the engine 14 can be adjusted to control the engine 14 speed. For example, if the harvester begins a steep uphill grade, the transport load 66 increases significantly, this will first be addressed by the engine 14 governor. If the engine 14 governor is unable to compensate for the increased engine 14 load then the transmission must be adjusted, the load on the engine 14 can be further controlled by adjusting the setting of the transmission. Similarly, if the density of the processing increases, the crop load 70 increases, but again the engine 14 load can be controlled by adjusting the setting of the transmission to compensate for the increase in processing load by reducing the transport speed of the harvester, thereby reducing the transport load 66 on the engine 14.

The setting of the hydrostatic transmission 18 in an operator manned machine is regulated by a control lever which is normally adjusted manually by means of a cable leading to the vehicle cab where it is accessible to the vehicle operator through a suitable control lever or knob. It is moved forward from its neutral position for driving the vehicle in the forward direction, and rearward from its neutral position for driving the vehicle in the reverse direction. As the control lever is moved away from neutral in either direction, it progressively increases the speed ratio between the engine 14 and the transport wheels 16, which has the effect of increasing the transport load 66 on the engine 14.

In accordance with the present invention, a transmission control system “linear actuator 56” adjusts the setting of the hydrostatic transmission 18, and thus the transport load 66 applied to the engine 14 via said transmission, in response to changes in the speed of the engine 14, with the adjustments in the transmission setting changing the engine 14 load according to a pulse characteristic based upon an operator decided factor. The factor is put into the controller by the operator through a calibration process. This enables the operator to select the reactivity speed which will determine the response rate of the harvester. A higher factor number enables a faster reaction rate to forces acting on the two harvester loads, transport load 66 and crop load 70. The system does not differentiate between the loads but rather reacts to the combination of both loads. The reaction thus causes the linear actuator 56 to adjust the flow of the hydrostat pump 68 to the transmission increasing or decreasing the transport speed in accordance with the appropriate action required.

In the particular embodiment illustrated in FIG. 2, the transmission control system includes an electro linear actuator 56 having an output member which is connected to the transmission control lever through a mechanical linkage. Movement of the output member of the actuator is proportional to the magnitude of a DC electrical signal supplied to the actuator from an electronic control unit determined by the operator programmable factor.

In the preferred embodiment of the invention, the proportional actuator is an electro linear actuator 56 that converts electrical pulses supplied by the control box 54 to corresponding mechanical displacement in the position of an output shaft. To the magnitude of the electrical signal which energizes the linear actuators internal motor winding causing the motor to turn and drive a gear that changes the position of the actuators shaft in a linear and incremental motion.

Input information is supplied by the engine RPM sensor 60 and the transmission speed sensor 58. Power from the control box 54 passes through the clutch switch 62 before arriving at the linear actuator 56

Referring to FIG. 3 in a preferred embodiment of the present invention the invention consists of a control box 54 equipped with a processor, memory, display 106 and operator controls. The control box 54 is programmable and calibrateable. A wire harness 64 with branches to pick up signals from the engine RPM sensor 60, transmission speed sensor 58 and linear actuator potentiometer 74. An electro mechanical linear actuator 56 equipped with a linear actuator clutch 76 and potentiometer.

The control box 54 being equipped with the ability to calibrate the hydrostat neutral position 78, hydrostat full forward position 80, engine RPM 82, and ground speed 92.

Operator selectable settings for target engine RPM 84, maximum engine RPM 86, minimum engine RPM 88, slug prevention 90 RPM, maximum ground speed 94, minimum ground speed 96, pulses per second 98, pulse length 100, slug pulses 102 and slug pulse length 104.

In the preferred embodiment of this present invention the combined inputs, calibrations and operator settings permit the present invention to effect the hydrostat pump 68 controlling the hydrostat transmission and ultimately the ground wheels 16 increasing or decreasing their rotational speed to influence engine 14 load and RPM's.

Referring now to FIG. 4, in a preferred embodiment of the present invention a controller is powered by the harvesters DC electrical power source 128 contains a processor to detect signals from the harvester and uses those signals in conjunction with operator input settings and its internal program to effect the operation of the harvester to the benefit of the operator. The controller is equipped with a display 106, on/off switch 114, motor fuse 108, clutch fuse 110, indicator lights for running, calibration, clutch and fault, operator input buttons for run button 116, calibrate button 118, set button 112, select up button 120 and select down button 122 for movement in the menu.

In the preferred embodiment the controller contains a processor of the HC6812 family. The processor is equipped with a memory for retaining the calibration and user selected settings. Information is then processed and signals are sent to the linear actuator 56 to effect a change on the forward speed of the harvester to maintain the proper operating parameters selected by the operator. Information on the harvester's current operating parameters is gained from the engine RPM sensor 60, transmission speed sensor 58 and the linear actuator potentiometer 74 through the present inventions wire harness 64. This information is analyzed and the processor determines if that information is within the operator selected parameters. If the signals indicate the harvester is operating within selected parameters then no effect takes place, if the signals received are not within the parameters selected for the harvester, then an effect takes place.

If the signals received are out of the range of parameters selected the controller engages a relay that will power the actuator causing the linear actuator shaft 124 to move in one direction or the other to cause the desired reaction. The power from the controller passes by means of the controller wire harness 64 through the clutch switch 62. The clutch switch 62 in a preferred embodiment is attached to the hydrostat handle 52 where an operator is employed to operate the harvester and the clutch switch 62 is attached to a remote control device where a robotic or remote control is used. The clutch switch 62 interrupts power to the actuator clutch allowing it to freewheel. The freewheeling clutch permits the operator to instantly take manual control of the hydrostat handle 52 overriding the automatic control provided by the present invention.

The linear actuator 56 moves the hydrostatic pump flow control from a neutral position to a forward position and from a forward position to a neutral position with infinite increments in either direction. When the hydrostat pump 68 flow control is opened, fluid flows to the transmission by means of hydraulic plumbing 126 causing the drive wheels 16 to move the harvester.

It is understood that this preferred embodiment does not cover all descriptions of all fluid drive systems that the present invention is applicable too but will operate.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An engine load control for hydrostaticaly driven equipment for maintaining a consistent engine rpm or load by varying the ground speed, comprising:
means for providing the harvester operator a means to calibrate the monitoring system followed by a display of those functions for the operator to observe. it further provides the operator a means of selecting the various parameters that he chooses the harvester to operate within. these parameters include but are not limited too; engine rpm including the target rpm and the highest and lowest allowable rpm that the operator chooses to allow the machine to operate within. engine rpm extreme drop to permit the operator to choose what parameters the load control will use extreme speed to prevent slugging of the machine. groundspeed to prevent the unit from accidentally engaging when the machine is not moving but rpm is increased to the point that otherwise the machine would be in operation. reaction speed at which the load control makes its changes to the harvesters forward speed permitting the operator to control how fast or slow the response time is to the changes encountered permitting adaptability to all machines and all crop conditions. a neutral stop position to prevent accidental engagement of the harvester into the rear drive position under extreme reaction conditions where the harvester must be stopped to prevent slugging and damage;
means for moving the hydrostatic or other drive lever to control the ground speed of the machine as a result of electrical impulses from the control box. providing a position readout for purposes of safety to prevent the linear actuator from entering a position that would endanger operator or machine;
means for making and breaking power to the linear actuator clutch allowing the operator instant disconnect of the automated system;
means for connecting the control box to the linear actuator, clutch switch, engine sensor, transmission sensor and power supply;
means for indicating the position of the shaft on the linear actuator;
means for securing the linear actuator motor to the linear actuator shaft so that power can be applied to move the shaft in a push or pull direction and to release the shaft so that it may freewheel when push or pull movements are not required;
means for causing the harvester to remain motionless, not in a forward or rearward drive mode. this position is noted in the control box and if the harvester were to use excessive movement on the hydrostat that may cause the harvester to enter a rear driving position, the control box would use this position as a reference to prevent actual engagement of the rearward drive capability as a safety factor;
means for referencing the forward most position of the linear actuator for safety purposes;
means for indicating the optimum engine rpm for the crop being harvested;
means for limiting the upper range of the engine rpm through increased transport load;
means for permitting the below acceptable harvester engine rpm to be raised by slowing the ground speed;
means for moving the harvester to a slower speed at an accelerated rate. to prevent the harvester from slugging or plugging. jamming of the harvester is prevented by extremely fast acting of the linear actuator reducing the forward speed in an attempt to limit further crop intake;
means for associating the signals received from the ground speed sensor to the actual miles per hour of the harvester;
means for setting a maximum ground speed on the harvester to prevent harvester from traveling at speeds faster than are safely handled under both transport and processing operations;
means for setting the minimum ground speed that the automatic control will be activated to prevent accidental activation should target engine rpm's be reached while a person or object is in front of the harvester. this safety feature eliminates the loss of life or property that could occur should an operator cause the harvester to reach target rpm's while the machine was being worked on or observed from the front;
means for determining the speed at which the linear actuator moves. a number indicating how many pulses per second is selected by the operator which is implemented if the control box determines the engine is operating out of parameters selected for the engine to operate within;
means for determining the length of each pulse or time that power is applied to the linear actuator. a larger pulse length number is equal to a longer period of time power is transmitted to the linear actuator motor which equates to a greater movement of the linear actuator shaft which equates to a faster change of the hydraulic fluid flow. a lower number translates into the opposite occurring;
means for determining the speed at which the pulses occur per second under the slug prevention function. the higher the number the more pulses per second occur and the faster the linear actuator shaft travels. the lower the number the slower it moves;
means for determining the length of time the power is transmitted to the linear actuator under the slug prevention function of the control box. the greater the number the longer period of time that power is transmitted and the lower the number the shorter the period of time the power is transmitted;
means for displaying information pertinent to the operator; and
means for moving the hydraulic pump flow control in an infinite number incremental movements from a no flow position to a full flow position.

2. The engine load control for hydrostaticaly driven equipment in accordance with claim 1, wherein said means for providing the harvester operator a means to calibrate the monitoring system followed by a display of those functions for the operator to observe. it further provides the operator a means of selecting the various parameters that he chooses the harvester to operate within. these parameters include but are not limited too; engine rpm including the target rpm and the highest and lowest allowable rpm that the operator chooses to allow the machine to operate within. engine rpm extreme drop to permit the operator to choose what parameters the load control will use extreme speed to prevent slugging of the machine. groundspeed to prevent the unit from accidentally engaging when the machine is not moving but rpm is increased to the point that otherwise the machine would be in operation. reaction speed at which the load control makes its changes to the harvesters forward speed permitting the operator to control how fast or slow the response time is to the changes encountered permitting adaptability to all machines and all crop conditions. a neutral stop position to prevent accidental engagement of the harvester into the rear drive position under extreme reaction conditions where the harvester must be stopped to prevent slugging and damage comprises an operater selectable, reads sensors, emits voltage, monitors engine rpm, monitors ground speed, contains saftey settings, programable, displays sensor readouts, generally a rectangular cube, mountable control box.

3. The engine load control for hydrostaticaly driven equipment in accordance with claim 1, wherein said means for moving the hydrostatic or other drive lever to control the ground speed of the machine as a result of electrical impulses from the control box. providing a position readout for purposes of safety to prevent the linear actuator from entering a position that would endanger operator or machine comprises an unit that moves on a linear axis, pull force, push force, trackable linear actuator.

4. The engine load control for hydrostaticaly driven equipment in accordance with claim 1, wherein said means for making and breaking power to the linear actuator clutch allowing the operator instant disconnect of the automated system comprises an on/off electrical switch, small clutch switch.

5. The engine load control for hydrostaticaly driven equipment in accordance with claim 1, wherein said means for connecting the control box to the linear actuator, clutch switch, engine sensor, transmission sensor and power supply comprises an electricaly conductive wires, conectors, insulated wire harness.

6. The engine load control for hydrostaticaly driven equipment in accordance with claim 1, wherein said means for indicating the position of the shaft on the linear actuator comprises a position indicating, electronic linear actuator potentiometer.

7. The engine load control for hydrostaticaly driven equipment in accordance with claim 1, wherein said means for securing the linear actuator motor to the linear actuator shaft so that power can be applied to move the shaft in a push or pull direction and to release the shaft so that it may freewheel when push or pull movements are not required comprises an electronic, resistive, remotely operated, gripping, controllable linear actuator clutch.

8. The engine load control for hydrostaticaly driven equipment in accordance with claim 1, wherein said means for causing the harvester to remain motionless, not in a forward or rearward drive mode. this position is noted in the control box and if the harvester were to use excessive movement on the hydrostat that may cause the harvester to enter a rear driving position, the control box would use this position as a reference to prevent actual engagement of the rearward drive capability as a safety factor comprises a non pumping hydrostat neutral position.

9. The engine load control for hydrostaticaly driven equipment in accordance with claim 1, wherein said means for referencing the forward most position of the linear actuator for safety purposes comprises a reference point hydrostat full forward position.

10. The engine load control for hydrostaticaly driven equipment in accordance with claim 1, wherein said means for indicating the optimum engine rpm for the crop being harvested comprises a selectable, retainable target engine rpm.

11. The engine load control for hydrostaticaly driven equipment in accordance with claim 1, wherein said means for limiting the upper range of the engine rpm through increased transport load comprises a selectable, retainable maximum engine rpm.

12. The engine load control for hydrostaticaly driven equipment in accordance with claim 1, wherein said means for permitting the below acceptable harvester engine rpm to be raised by slowing the ground speed comprises a selectibale, retainable minimum engine rpm.

13. The engine load control for hydrostaticaly driven equipment in accordance with claim 1, wherein said means for moving the harvester to a slower speed at an accelerated rate. to prevent the harvester from slugging or plugging. jamming of the harvester is prevented by extremely fast acting of the linear actuator reducing the forward speed in an attempt to limit further crop intake comprises a fast acting, programable, retainable slug prevention.

14. The engine load control for hydrostaticaly driven equipment in accordance with claim 1, wherein said means for associating the signals received from the ground speed sensor to the actual miles per hour of the harvester comprises a programable, retainable ground speed.

15. The engine load control for hydrostaticaly driven equipment in accordance with claim 1, wherein said means for setting a maximum ground speed on the harvester to prevent harvester from traveling at speeds faster than are safely handled under both transport and processing operations comprises a programable, retainable maximum ground speed.

16. The engine load control for hydrostaticaly driven equipment in accordance with claim 1, wherein said means for setting the minimum ground speed that the automatic control will be activated to prevent accidental activation should target engine rpm's be reached while a person or object is in front of the harvester. this safety feature eliminates the loss of life or property that could occur should an operator cause the harvester to reach target rpm's while the machine was being worked on or observed from the front comprises a programable, retainable minimum ground speed.

17. The engine load control for hydrostaticaly driven equipment in accordance with claim 1, wherein said means for determining the speed at which the linear actuator moves. a number indicating how many pulses per second is selected by the operator which is implemented if the control box determines the engine is operating out of parameters selected for the engine to operate within comprises a programable, retainable pulses per second.

18. The engine load control for hydrostaticaly driven equipment in accordance with claim 1, wherein said means for determining the length of each pulse or time that power is applied to the linear actuator. a larger pulse length number is equal to a longer period of time power is transmitted to the linear actuator motor which equates to a greater movement of the linear actuator shaft which equates to a faster change of the hydraulic fluid flow. a lower number translates into the opposite occurring comprises a programable, retainable pulse length.

19. The engine load control for hydrostaticaly driven equipment in accordance with claim 1, wherein said means for determining the speed at which the pulses occur per second under the slug prevention function. the higher the number the more pulses per second occur and the faster the linear actuator shaft travels. the lower the number the slower it moves comprises a programable, retainable slug pulses.

20. The engine load control for hydrostaticaly driven equipment in accordance with claim 1, wherein said means for determining the length of time the power is transmitted to the linear actuator under the slug prevention function of the control box. the greater the number the longer period of time that power is transmitted and the lower the number the shorter the period of time the power is transmitted comprises a programable, retainable slug pulse length.

21. The engine load control for hydrostaticaly driven equipment in accordance with claim 1, wherein said means for displaying information pertinent to the operator comprises a lighted, readable display.

22. The engine load control for hydrostaticaly driven equipment in accordance with claim 1, wherein said means for moving the hydraulic pump flow control in an infinite number incremental movements from a no flow position to a full flow position comprises a rigid, strong, smooth, guided linear actuator shaft.

23. An engine load control for hydrostaticaly driven equipment for maintaining a consistent engine rpm or load by varying the ground speed, comprising:
an operater selectable, reads sensors, emits voltage, monitors engine rpm, monitors ground speed, contains saftey settings, programable, displays sensor readouts, generally a rectangular cube, mountable control box, for providing the harvester operator a means to calibrate the monitoring system followed by a display of those functions for the operator to observe. it further provides the operator a means of selecting the various parameters that he chooses the harvester to operate within. these parameters include but are not limited too; engine rpm including the target rpm and the highest and lowest allowable rpm that the operator chooses to allow the machine to operate within. engine rpm extreme drop to permit the operator to choose what parameters the load control will use extreme speed to prevent slugging of the machine. groundspeed to prevent the unit from accidentally engaging when the machine is not moving but rpm is increased to the point that otherwise the machine would be in operation. reaction speed at which the load control makes its changes to the harvesters forward speed permitting the operator to control how fast or slow the response time is to the changes encountered permitting adaptability to all machines and all crop conditions. a neutral stop position to prevent accidental engagement of the harvester into the rear drive position under extreme reaction conditions where the harvester must be stopped to prevent slugging and damage;
an unit that moves on a linear axis, pull force, push force, trackable linear actuator, for moving the hydrostatic or other drive lever to control the ground speed of the machine as a result of electrical impulses from the control box. providing a position readout for purposes of safety to prevent the linear actuator from entering a position that would endanger operator or machine;
an on/off electrical switch, small clutch switch, for making and breaking power to the linear actuator clutch allowing the operator instant disconnect of the automated system;
an electricaly conductive wires, conectors, insulated wire harness, for connecting the control box to the linear actuator, clutch switch, engine sensor, transmission sensor and power supply;
a position indicating, electronic linear actuator potentiometer, for indicating the position of the shaft on the linear actuator;
an electronic, resistive, remotely operated, gripping, controllable linear actuator clutch, for securing the linear actuator motor to the linear actuator shaft so that power can be applied to move the shaft in a push or pull direction and to release the shaft so that it may freewheel when push or pull movements are not required;
a non pumping hydrostat neutral position, for causing the harvester to remain motionless, not in a forward or rearward drive mode. this position is noted in the control box and if the harvester were to use excessive movement on the hydrostat that may cause the harvester to enter a rear driving position, the control box would use this position as a reference to prevent actual engagement of the rearward drive capability as a safety factor;
a reference point hydrostat full forward position, for referencing the forward most position of the linear actuator for safety purposes;
a selectable, retainable target engine rpm, for indicating the optimum engine rpm for the crop being harvested;
a selectable, retainable maximum engine rpm, for limiting the upper range of the engine rpm through increased transport load;
a selectibale, retainable minimum engine rpm, for permitting the below acceptable harvester engine rpm to be raised by slowing the ground speed;
a fast acting, programable, retainable slug prevention, for moving the harvester to a slower speed at an accelerated rate. to prevent the harvester from slugging or plugging. jamming of the harvester is prevented by extremely fast acting of the linear actuator reducing the forward speed in an attempt to limit further crop intake;
a programable, retainable ground speed, for associating the signals received from the ground speed sensor to the actual miles per hour of the harvester;
a programable, retainable maximum ground speed, for setting a maximum ground speed on the harvester to prevent harvester from traveling at speeds faster than are safely handled under both transport and processing operations;
a programable, retainable minimum ground speed, for setting the minimum ground speed that the automatic control will be activated to prevent accidental activation should target engine rpm's be reached while a person or object is in front of the harvester. this safety feature eliminates the loss of life or property that could occur should an operator cause the harvester to reach target rpm's while the machine was being worked on or observed from the front;
a programable, retainable pulses per second, for determining the speed at which the linear actuator moves. a number indicating how many pulses per second is selected by the operator which is implemented if the control box determines the engine is operating out of parameters selected for the engine to operate within;
a programable, retainable pulse length, for determining the length of each pulse or time that power is applied to the linear actuator. a larger pulse length number is equal to a longer period of time power is transmitted to the linear actuator motor which equates to a greater movement of the linear actuator shaft which equates to a faster change of the hydraulic fluid flow. a lower number translates into the opposite occurring;
a programable, retainable slug pulses, for determining the speed at which the pulses occur per second under the slug prevention function. the higher the number the more pulses per second occur and the faster the linear actuator shaft travels. the lower the number the slower it moves;
a programable, retainable slug pulse length, for determining the length of time the power is transmitted to the linear actuator under the slug prevention function of the control box. the greater the number the longer period of time that power is transmitted and the lower the number the shorter the period of time the power is transmitted;
a lighted, readable display, for displaying information pertinent to the operator; and
a rigid, strong, smooth, guided linear actuator shaft, for moving the hydraulic pump flow control in an infinite number incremental movements from a no flow position to a full flow position.

24. An engine load control for hydrostaticaly driven equipment for maintaining a consistent engine rpm or load by varying the ground speed, comprising:
an operater selectable, reads sensors, emits voltage, monitors engine rpm, monitors ground speed, contains saftey settings, programable, displays sensor readouts, generally a rectangular cube, mountable control box, for providing the harvester operator a means to calibrate the monitoring system followed by a display of those functions for the operator to observe. it further provides the operator a means of selecting the various parameters that he chooses the harvester to operate within. these parameters include but are not limited too; engine rpm including the target rpm and the highest and lowest allowable rpm that the operator chooses to allow the machine to operate within. engine rpm extreme drop to permit the operator to choose what parameters the load control will use extreme speed to prevent slugging of the machine. groundspeed to prevent the unit from accidentally engaging when the machine is not moving but rpm is increased to the point that otherwise the machine would be in operation. reaction speed at which the load control makes its changes to the harvesters forward speed permitting the operator to control how fast or slow the response time is to the changes encountered permitting adaptability to all machines and all crop conditions. a neutral stop position to prevent accidental engagement of the harvester into the rear drive position under extreme reaction conditions where the harvester must be stopped to prevent slugging and damage;
an unit that moves on a linear axis, pull force, push force, trackable linear actuator, for moving the hydrostatic or other drive lever to control the ground speed of the machine as a result of electrical impulses from the control box. providing a position readout for purposes of safety to prevent the linear actuator from entering a position that would endanger operator or machine;
an on/off electrical switch, small clutch switch, for making and breaking power to the linear actuator clutch allowing the operator instant disconnect of the automated system;
an electricaly conductive wires, conectors, insulated wire harness, for connecting the control box to the linear actuator, clutch switch, engine sensor, transmission sensor and power supply;
a position indicating, electronic linear actuator potentiometer, for indicating the position of the shaft on the linear actuator;
an electronic, resistive, remotely operated, gripping, controllable linear actuator clutch, for securing the linear actuator motor to the linear actuator shaft so that power can be applied to move the shaft in a push or pull direction and to release the shaft so that it may freewheel when push or pull movements are not required;
a non pumping hydrostat neutral position, for causing the harvester to remain motionless, not in a forward or rearward drive mode. this position is noted in the control box and if the harvester were to use excessive movement on the hydrostat that may cause the harvester to enter a rear driving position, the control box would use this position as a reference to prevent actual engagement of the rearward drive capability as a safety factor;
a reference point hydrostat full forward position, for referencing the forward most position of the linear actuator for safety purposes;
a selectable, retainable target engine rpm, for indicating the optimum engine rpm for the crop being harvested;
a selectable, retainable maximum engine rpm, for limiting the upper range of the engine rpm through increased transport load;
a selectibale, retainable minimum engine rpm, for permitting the below acceptable harvester engine rpm to be raised by slowing the ground speed;
a fast acting, programable, retainable slug prevention, for moving the harvester to a slower speed at an accelerated rate. to prevent the harvester from slugging or plugging. jamming of the harvester is prevented by extremely fast acting of the linear actuator reducing the forward speed in an attempt to limit further crop intake;
a programable, retainable ground speed, for associating the signals received from the ground speed sensor to the actual miles per hour of the harvester;
a programable, retainable maximum ground speed, for setting a maximum ground speed on the harvester to prevent harvester from traveling at speeds faster than are safely handled under both transport and processing operations;
a programable, retainable minimum ground speed, for setting the minimum ground speed that the automatic control will be activated to prevent accidental activation should target engine rpm's be reached while a person or object is in front of the harvester. this safety feature eliminates the loss of life or property that could occur should an operator cause the harvester to reach target rpm's while the machine was being worked on or observed from the front;
a programable, retainable pulses per second, for determining the speed at which the linear actuator moves. a number indicating how many pulses per second is selected by the operator which is implemented if the control box determines the engine is operating out of parameters selected for the engine to operate within;
a programable, retainable pulse length, for determining the length of each pulse or time that power is applied to the linear actuator a larger pulse length number is equal to a longer period of time power is transmitted to the linear actuator motor which equates to a greater movement of the linear actuator shaft which equates to a faster change of the hydraulic fluid flow a lower number translates into the opposite occurring;
a programable, retainable slug pulses, for determining the speed at which the pulses occur per second under the slug prevention function. the higher the number the more pulses per second occur and the faster the linear actuator shaft travels the lower the number the slower it moves;
a programable, retainable slug pulse length, for determining the length of time the power is transmitted to the linear actuator under the slug prevention function of the control box. the greater the number the longer period of time that power is transmitted and the lower the number the shorter the period of time the power is transmitted;
a lighted, readable display, for displaying information pertinent to the operator; and
a rigid, strong, smooth, guided linear actuator shaft, for moving the hydraulic pump flow control in an infinite number incremental movements from a no flow position to a full flow position.
